(19) United States
(12) Patent Application Publication
(10) Pub. No.: US 2014/0239242 A1
(43) Pub. Date: Aug. 28, 2014

(54) LASER PROTECTION MATERIAL AND LASER PROTECTION COMPONENT

(71) Applicant: LASERVISION GmbH & Co., KG, Fürth (DE)

(72) Inventor: Thomas FRÖHLICH, Lauf an der Pegnitz (DE)

(73) Assignee: LASERVISION GmbH & Co., KG, Fürth (DE)

(21) Appl. No.: 14/190,488

(22) Filed: Feb. 26, 2014

(30) Foreign Application Priority Data
Feb. 26, 2013 (DE) 10 2013 203 120.3

(51) Int. Cl. G02B 5/20; G02B 1/04

(52) U.S. Cl. CPC G02B 5/208; G02B 1/04
USPC 252/587

(57) ABSTRACT

The laser protection material is intended for use in a laser protection filter having an effective wavelength range. The laser protection material has a matrix material of a plastic that is transparent in the effective wavelength range and an absorber material that is embedded into the matrix material in a substantially homogeneous manner, wherein the absorber material absorbs a laser radiation in the effective wavelength range and loses its absorptive capacity in the effective wavelength range when heated to a temperature above a threshold temperature, and wherein the plastic of the matrix material starts to foam when heated to a temperature above the threshold temperature.

### CROSS-REFERENCES TO RELATED APPLICATIONS

This application claims the priority of Patent Application Serial No. DE 10 2013 203 120.3, filed on 26 Feb. 2013, pursuant to 35 U.S.C. 119(a)-(d), the content of which is incorporated herein by reference in its entirety as if fully set forth herein.

### FIELD OF THE INVENTION

The invention relates to a laser protection material for a laser protection filter having an effective wavelength range and a laser protection component made of a laser protection material of this type.

### BACKGROUND OF THE INVENTION

Various laser protection materials are already known. These materials are used to produce, among other things, protection filters for use in laser protection spectacles and/or laser protection screens. These filters offer protection against radiation emitted by diode lasers, solid state lasers, disk lasers, fiber lasers and titanium sapphire lasers. The most common plastic material used in the production of protection filters of this type is polycarbonate. The filter effect is in the near infrared range for wavelengths between 750 nm and 1150 nm. Polycarbonate based protection filters of this type allow laser protection levels of up to D LB6 according to EN 207:2009 to be achieved. However, a maximum laser protection level D LB6 is often not sufficient, in particular in the field of laser material processing.

DE 10 2005 009 613 A1 describes a laser protection material in the form of a polymer composite material in which a structural change occurs as a reaction to the energy absorption taking place when the material is exposed to laser radiation.

US 2009/0204186 A1 and EP 0 992 832 A1 each describe spectacle lenses, wherein the material of these spectacle lenses comprises a matrix material of plastic, in particular of polyurethane, that is transparent in the visible wavelength range and an absorber material, in particular a UV blocker, that is homogeneously embedded into the matrix material.

DE 10 2006 003 450 A2 and WO 94/15557 A2 each describe a laser protection device comprising a layer of completely foamed material.

DE 20 2006 020 429 U1 describes a method for the production of a trim part provided with a shiny transparent plastic coating for use in a vehicle. The transparent plastic coating is a polyurethane coating that is produced by injecting a polyol component and an isocyanate component into an injection mold, wherein a matting agent such as silicic acid is added to the polyol component in order to obtain the shiny effect.

### SUMMARY OF THE INVENTION

An object of the invention is therefore to provide a laser protection material of the type defined at the outset that allows a higher laser protection level to be achieved than by means of prior art laser protection materials.

This object is achieved by a laser protection material for a laser protection filter having an effective wavelength range, the laser protection material comprising a matrix material of a plastic that is transparent in the effective wavelength range and an absorber material that is substantially homogeneously embedded into the matrix material, wherein the absorber material absorbs a laser radiation in the effective wavelength range and loses its absorptive capacity in the effective wavelength range when heated to a temperature above a threshold temperature, wherein the plastic of the matrix material starts to foam when heated to a temperature above the threshold temperature.

It was found within the scope of the invention that a laser protection material of this type is advantageously used in the production of a laser protection filter. The effective wavelength range can also be interpreted as protective wavelength range, in other words the filter and/or protective effect can be observed when exposed to an incident laser radiation having a wavelength of this range. The laser protection material according to the invention allows a very high laser protection level according to EN 207:2009 of in particular at least D LB7 and maybe of even up to D LB8 to be achieved in the effective wavelength range defined above. A protection level of this magnitude is achieved by means of various aspects.

One important aspect is the absorber material which is embedded or blended into or dissolved in the matrix material, wherein the absorber material, which is advantageously a colorant, is in particular temperature-sensitive. This preferably thermally instable material absorbs the incident laser radiation as long as the temperature does not exceed a threshold value. When heated to a temperature above said threshold temperature, the absorber material in particular starts to fade and/or decompose, causing the absorber material to lose its absorptive capacity. At first glance, this behavior is unfavorable because when the absorber material has faded and/or decomposed, the incident laser radiation will then penetrate into the laser protection material without being absorbed by the absorber material. It was however found within the scope of the invention that this particular behavior, which seems unfavorable at first glance, can advantageously be combined with the properties of the matrix material, ultimately resulting in a much higher laser protection level than ever before.

The absorptive capacity of the absorber material increases the temperature in the plastic of the matrix material up to its decomposition. Above the threshold temperature, a localized foaming process occurs in the matrix material that is in particular at least partly caused by a thermal decomposition of the matrix material. The absorber material in particular contained in the foam which develops in this foaming process has lost its absorptive capacity as a result of the impact of heat. The foam is now, on the contrary, substantially transparent to the laser radiation that continues to impinge on the material. The structure of the foamed plastic of the matrix material however causes the laser radiation to be extremely scattered so that the surface area exposed to the laser radiation increases, causing the power density (=power per surface area) to decrease so that the decomposition of the matrix material and therefore of the laser protection material comes to a halt.

In other words, the absorber material initially causes the matrix material to heat up so that the material starts to foam in the region of the incident laser radiation, causing the incident laser radiation to be scattered and, consequently, the dangerously high laser power density to be reduced. As the described effects go hand in hand, the protective effect of the laser protection material is improved considerably, allowing higher laser protection levels to be achieved than by means of prior art materials.

Another advantage is that when the laser protection material is in use, disturbances are easy to recognize by means of the foam which develops in the area of laser impingement. This allows countermeasures to be taken, for instance a correction of the disturbances in the installation the laser radiation was used in and which is surrounded by the laser protection material for protection against said laser radiation, or—if necessary—a replacement of the laser protection material if it is too severely damaged to provide sufficient protection when exposed to laser radiation again.

The following is a description of advantageous embodiments of the laser protection material according to the invention.

According to a favorable embodiment, the matrix material shows an intrinsic foaming behavior. The favorable foaming of the matrix material is then in particular achieved without requiring a particular foaming agent. This reduces both the production expenditures as well as the production costs.

According to another favorable embodiment, the matrix material is a thermosetting polyurethane. This plastic material is a known material that is well available on the market and also shows the foaming behavior required according to the invention when heated to a temperature above a particular threshold temperature.

According to another favorable embodiment, the polyurethane is a plastic material produced according to a RIM method. This method takes place at low temperatures, for instance even at ambient temperature. The heat of reaction generated when the monomers are polymerized causes the matrix material to be heated to a temperature of no more than approximately 100° C. In any case the temperature does not exceed the threshold temperature at which the absorber material starts to decompose and/or the matrix material starts to foam. The RIM method is a very effective method to produce thermosetting molded parts made of polyurethane such as for instance a laser protection filter having a shape that is more or less freely selectable.

According to another favorable embodiment, the polyurethane is produced from polyol and isocyanate in a selectable mixing ratio. The favorable aspect of this embodiment is that the mixing ratio allows the mechanical strength, in particular the mechanical hardness and the mechanical elasticity of the laser protection component produced from the laser protection material, to be defined. As a result, it is conceivable to produce roll-up films as well as mechanically stable screens to be used as laser protection filters in laser protection spectacles or laser protection screens.

According to another favorable embodiment, the absorber material is either blended into the polyol or into the isocyanate in a substantially homogeneous manner. By adding the absorber material to one of the monomer components, the absorber material is very evenly embedded into the resulting polyurethane matrix material.

According to another favorable embodiment, the absorber material is blended into the polyol. This facilitates the production since blending the absorber material into the isocyanate, which is in principle conceivable as well, would result in a much more complicated production process because of the highly toxic properties of this monomer.

According to another favorable embodiment, the absorber material is a colorant from or including amminium or from or including a cyanine or from or including a heavy metal complex. These substances are easily blended into the plastic matrix material. Another one of their properties is that they lose their absorptive capacity when heated above a threshold temperature, as required according to the invention. The heavy metal complex may in particular be a nickel based complex.

According to another favorable embodiment, the absorber material is embedded into the matrix material in a selectable concentration. This allows the absorption behavior and in particular the volume range to be defined in which interaction with the laser radiation occurs. Preferably, the power or energy densities, which are required for this interaction to occur, can be defined as well, at least to some extent.

According to another favorable embodiment, a value of at least 100° C., in particular at least 150° C., and preferably at least 200° C. is defined as threshold temperature. Advantageously, the threshold temperature is then still above the production temperature in the production of the laser protection component produced from the laser protection material, with the result that the loss of absorptive capacity and the foaming of the matrix material will occur only in the event of a disturbance while exposed to high-energy laser radiation and not in the production.

According to another favorable embodiment, the effective wavelength range is between 750 nm and 1150 nm, and therefore in particular in the near infrared wavelength range. In this wavelength range, some very powerful laser applications are performed that require laser protection materials having a particularly high laser protection level.

According to another favorable embodiment, the matrix material is not only transparent in the effective wavelength range but also in another wavelength range. This is particularly advantageous when used in a laser protection filter of a pair of laser protection spectacles or of a laser protection screen. These laser protection components need to be transparent in the visible wavelength range, allowing the operating personnel to see through the laser protection filter. Naturally, a transparency is also required in the effective wavelength range which may however be different from the visible wavelength range. There are however other fields of application as well in which transparency is provided only in the effective wavelength range. Examples of such other applications are laser protection walls, laser protection curtains but also frames for laser protection spectacles or coatings for laser protection spectacles frames.

Another object of the invention is to provide a laser protection component having a laser protection level that is improved when compared to prior art laser protection components.

This object is achieved by means of a laser protection component according to the invention. The laser protection component according to the invention comprises an element made of the above-described laser protection material according to the invention or of its advantageous embodiments which are also described above. In other words, the laser protection material according to the invention and its advantageous embodiments are in particular used for the production of a laser protection component. Therefore, a laser protection component of this type and the embodiments thereof have substantially the same advantages as described above with reference to the laser protection material according to the invention and its embodiments.

The following is a description of advantageous embodiments of the laser protection component. According to a favorable embodiment, the element of the laser protection component is a laser protection filter of a pair of laser protection spectacles or a laser protection screen or a component of a laser protection wall or of a laser protection curtain. The element may also form the frame or part of the frame of a pair of laser protection spectacles or a laser protection screen. If this is the case, a laser protection filter is not only to be interpreted as a screen which is transparent for example in the visible wavelength range but also, on a more general basis as defined in the corresponding standardization provisions, as an element that blocks laser radiation in the specified effective wavelength range and prevents it from passing through. In this respect, laser protection walls and laser protection curtains are to be interpreted as laser protection filters of this type as well. In any case, the laser protection material may advantageously be provided in the laser protection components mentioned above. As a result, a very high laser protection level is obtained.

Further features, advantages and details of the invention will become apparent from the ensuing description of an exemplary embodiment in conjunction with the drawing.

### BRIEF DESCRIPTION OF THE DRAWING

FIG. 1 is a cross-sectional view of an exemplary embodiment of a laser protection component made of a foaming laser protection material; and

FIGS. 2 and 3 show the laser protection component according to FIG. 1 when exposed to a laser radiation.

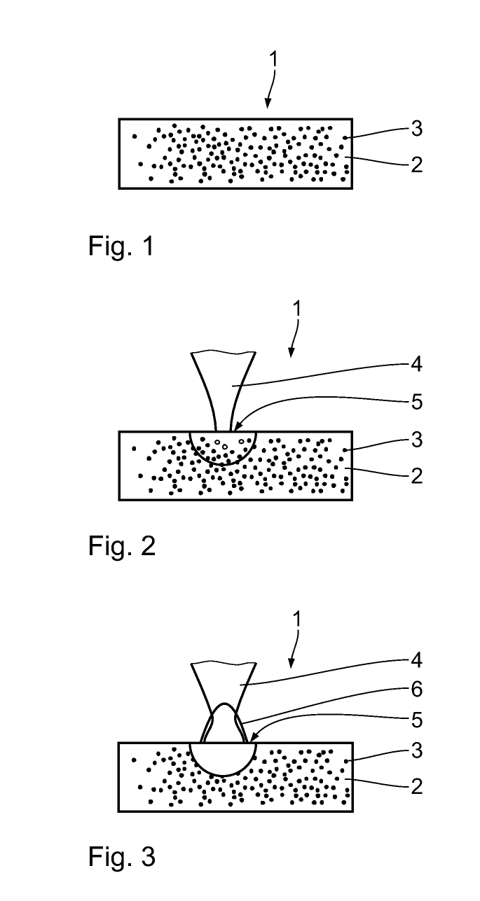

Mutually corresponding parts are referred to by the same reference numerals throughout FIGS. 1 to 3. Details of the exemplary embodiment described in more detail below may form an individual invention or part of an object of an invention.

### DESCRIPTION OF THE PREFERRED EMBODIMENT

FIG. 1 is a cross-sectional view of an exemplary embodiment of a laser protection component 1 in the form of a screen or a filter of a pair of laser protection spectacles. The laser protection component 1 is made of a laser protection material that comprises a matrix material 2 into which an absorber material 3 is embedded in a substantially homogeneous manner.

The matrix material 2 of the exemplary embodiment is a thermosetting polyurethane. In the illustrated embodiment, the absorber material 3 is a colorant on the basis of amminium.

The laser protection component 1 is specified for the near infrared wavelength range, thus preventing laser radiation 4 having a wavelength between 750 nm and 1150 nm from passing through the laser protection component 1. The laser protection component has a laser protection level according to EN 207:2009 of at least D LB 7.

The matrix material 2 of the laser protection material is transparent to laser radiation 4 in the specified effective wavelength range. The absorber material 3 on the other hand absorbs the laser radiation 4 in the effective wavelength range, at least in particular as long as the temperature does not exceed a threshold temperature.

The functioning of the laser protection component 1 when exposed to a laser radiation 4 is explained in the following by means of FIGS. 2 and 3.

In the area 5 in which the laser protection component 1 is exposed to laser radiation 4, the absorber material 3 at first absorbs the energy of the laser radiation 4. As a result, the local temperature in this area 5 increases. If, as a consequence of this temperature increase, the temperature exceeds a threshold temperature which is at approximately 260° C. in the exemplary embodiment, the colorant of the absorber material 3 fades and loses its absorptive capacity. Afterwards, its degree of transparency to the laser radiation 4 in the effective wavelength range is equal to that of the matrix material 2.

Furthermore, the local temperature increase causes the polyurethane of the matrix material 2, which is transparent to the laser radiation 4 in the effective wavelength range, to decompose so that it starts to foam. Shortly thereafter, a foam 6 is produced which is transparent to the laser radiation 4 because of the inherent transparency of the matrix material 2 on the one hand and because of the absorber material 3 on the other which has lost its absorptive capacity. The incident laser radiation 4 is therefore no longer absorbed in this area 5 and by the foam 6. Instead, the foam-like structure causes the laser radiation 4 to be extremely scattered. As a result, the surface area exposed to the laser radiation 4 is increased, causing the power density (power per surface area) to decrease so that the decomposition of the laser protection material of the laser protection component 1 comes to a halt.

The advantageous temperature-dependent absorptive capacity of the absorber material 3, which comprises a colorant that is thermally instable and loses its absorptive capacity when the threshold temperature is exceeded, and the foaming of the matrix material 2 made of thermosetting polyurethane that goes hand in hand with a temperature increase above the threshold temperature result in an extremely effective protection even in the event of a very powerful incident laser radiation 4. Consequently, a laser protection level as specified above of at least D LB7 is obtained which had not been achievable by means of prior art materials which had previously been used for protection against laser radiation.

What is claimed is:

1. A laser protection material for a laser protection filter (1) having an effective wavelength range, the laser protection material comprising
a) a matrix material (2) of a plastic which is transparent in the effective wavelength range, and
b) an absorber material (3) which is substantially homogeneously embedded into the matrix material (2), wherein the absorber material (3) absorbs a laser radiation (4) in the effective wavelength range and loses its absorptive capacity in the effective wavelength range when heated to a temperature above a threshold temperature, wherein
c) the plastic of the matrix material (2) starts to foam when heated to a temperature above the threshold temperature.

2. A laser protection material according to claim 1, wherein the matrix material (2) shows an intrinsic foaming behavior.

3. A laser protection material according to claim 1, wherein the matrix material (2) is a thermosetting polyurethane.

4. A laser protection material according to claim 3, wherein the polyurethane is a plastic produced according to a RIM method.

5. A laser protection material according to claim 3, wherein the polyurethane is produced from polyol and from isocyanate in a selectable mixing ratio.

6. A laser protection material according to claim 5, wherein the absorber material (3) is embedded into one of the group comprising polyol and isocyanate in a substantially homogeneous manner.

7. A laser protection material according to claim 6, wherein the absorber material (3) is blended into the polyol.

8. A laser protection material according to claim 1, wherein the absorber material (3) is a colorant from one of the group comprising amminium, a cyanine, and a heavy metal complex.

9. A laser protection material according to claim 1, wherein the absorber material (3) is a colorant including one of the group comprising amminium, a cyanine, and a heavy metal complex.

10. A laser protection material according to claim 1, wherein the absorber material (3) is embedded into the matrix material in a selectable concentration.

11. A laser protection material according to claim 1, wherein a value of at least 100° C. is defined as threshold temperature.

12. A laser protection material according to claim 1, wherein a value of at least 150° C. is defined as threshold temperature.

13. A laser protection material according to claim 1, wherein a value of at least 200° C. is defined as threshold temperature.

14. A laser protection material according to claim 1, wherein the effective wavelength range is between 750 nm and 1150 nm.

15. A laser protection material according to claim 1, wherein the matrix material (2) is transparent in another wavelength range differing from the effective wavelength range.

16. A laser protection component comprising an element made of the laser protection material according to the invention.

17. A laser protection component according to claim 16, wherein the element is a laser protection filter (1) of one of the group comprising a pair of laser protection spectacles, a laser protection screen, a component of a laser protection wall and a laser protection curtain.
